(19) United States
(12) Patent Application Publication
(10) Pub. No.: US 2026/0180317 A1
(43) Pub. Date: Jun. 25, 2026

(54) REVERSE ERMS

(71) Applicant: Schneider Electric USA, Inc., Andover, MA (US)

(72) Inventors: Kevin M. Jefferies, Raleigh, NC (US); Benjamin W. Edwards, Rolesville, NC (US)

(73) Assignee: Schneider Electric USA, Inc., Boston, MA (US)

(21) Appl. No.: 18/990,003

(22) Filed: Dec. 20, 2024

(51) Int. Cl. H02H 9/02; H02H 7/08

(52) U.S. Cl. CPC H02H 9/02; H02H 7/08

(57) ABSTRACT

In a method and system, a low-energy protection mode is implemented at a first trip current threshold setting for a circuit breaker(s) of an electrical system to provide arc flash protection and allow for user maintenance on or in proximity to electrical equipment on a protected circuit of the electrical system. If a higher current demand by the protected circuit or electrical equipment thereon is anticipated to exceed the first trip setting under normal equipment operation, the first trip setting is temporarily changed to a second trip current threshold setting for the breaker(s) to accommodate the higher current demand at a high-energy protection mode, and user maintenance is restricted on or near the electrical equipment on the electrical system during operation at the second trip setting. The second trip setting provides a higher allowable current on the protected circuit than the first trip setting.

### TECHNICAL FIELD

The present disclosure relates to circuit protection on an electrical system, and more particularly to a dynamic maintenance protection system and method which are adaptable to accommodate current demand of electrical equipment on a protected circuit of the electrical system.

### BACKGROUND

Electrical equipment on an electrical system typically requires periodic maintenance. For instance, electrical equipment often requires cleaning, repairs, testing, and/or adjustments. Further, some electrical equipment may require replacement. Consequently, there is a need to provide service personnel with means to create a safe working environment by disconnecting electricity to the equipment which the service personnel are servicing. One way to accomplish this disconnecting of electricity is to disconnect power with a circuit breaker where contacts can be opened and the operator mechanism can be padlocked in the “open” position to prevent accidental closing of contacts. Preventing the closing of contacts would prevent re-energizing the circuit. In general, facilities with electrical equipment have a specific procedure which establishes the minimum requirements for lockout of energy sources that could cause injury to service personnel. This procedure is commonly referred to as a lockout-tagout procedure.

Circuit protective devices, such as for example circuit breakers, are typically used as an integral component in a power-distribution system of an electrical system. Circuit breakers, in addition to providing overload current protection, can also be used as disconnect devices to de-energize downstream electrical distribution circuits as needed to perform, for example, maintenance. In some cases, however, it can occur that maintenance or access to electrical systems or components thereof must be done with such systems energized and this situation can present a significant risk for injury or property damage. To address this risk, industry rules and practices have evolved to create a “lower energy service mode” (also referred to herein as a maintenance protection mode) to reduce the afore-mentioned risks. In general, such a maintenance protection mode is turned ON when maintenance is to be performed on the electrical system or electrical equipment thereon, and is turned OFF when maintenance is completed.

### SUMMARY

In accordance with an embodiment, a method is provided to protect an electrical system. The method includes implementing a low energy protection mode at a first trip current threshold setting for a circuit protective device(s) of an electrical system to provide arc flash protection and allow for user maintenance on or in proximity to electrical equipment on a protected circuit of the electrical system. The method further includes, if a higher current demand by the protected circuit or the electrical equipment thereon is anticipated to exceed the first current threshold setting, (1) temporarily changing the first trip current threshold setting to a second trip current threshold setting for the circuit protective device(s) to accommodate the higher current demand at a high energy protection mode and (2) restricting user maintenance on or in proximity to the electrical equipment during operation at the second trip current threshold setting. The second trip current threshold setting provides for higher allowable current on the protected circuit than the first trip current threshold setting.

In various embodiments, the first trip current threshold setting for the circuit protective device(s) can be configured to prevent arc flash greater than or equal to an incident energy of 1.2 cal/cm².

In various embodiments, the first trip current threshold setting can be a default or normal trip current setting, and the second trip current threshold setting can be a trip current setting up to an overcurrent limit of the electrical equipment.

In various embodiments, the method can further include: monitoring current on the protected circuit or the electrical equipment thereon of the electrical system using one or more sensors; and determining the anticipated higher current demand by the protected circuit or the electrical equipment thereon based on the monitored current.

In various embodiments, the method can further include: determining the anticipated higher current demand by the protected circuit or the electrical equipment thereon based on a request for a higher or lower current mode for the protected circuit or based on information reflecting a higher or lower current demand in view of an anticipated activity or operation of the electrical equipment on the protected circuit. Furthermore, the anticipated activity or operation can include motor starting or stall conditions associated with motor starting equipment housed in one or more drawers of one or more cabinets of a motor control center, or increasing power output on a variable speed drive.

In various embodiments, the operation of the restricting user maintenance can include: locking or moving a position of an enclosure or component thereof for the electrical equipment on the protected circuit during operation at the second trip current threshold setting for the circuit protective device(s). The operation at the second trip current threshold setting may be implemented temporarily (e.g., for a temporary duration or period) according to the current demand of the protected circuit or the electrical equipment thereon. Furthermore, the electrical equipment can be at least a motor starter(s), and the enclosure can be a lockable drawer(s) of a motor control center.

In various embodiments, the method can further include: determining whether current to the electrical equipment on the protected circuit exceeds the second trip current threshold setting; and in response to the determination that the current exceeds the second trip current threshold setting, tripping the circuit protective device(s) to interrupt current to the protected circuit of the electrical system.

In various embodiments, the method can further include: returning a trip setting from the second trip current threshold setting to the first trip current threshold setting for the circuit protective device(s) on the electrical system; and allowing user maintenance on or in proximity to the electrical equipment on the electrical system. Furthermore, the trip setting can be returned from the second trip current threshold setting to the first trip current threshold setting, after a predefined period of time or if the current demand by the electrical equipment on the protected circuit no longer exceeds the first current threshold setting.

In various embodiments, the circuit protective device(s) can be a circuit breaker(s). Furthermore, in various embodiments, the low energy protection mode can be an energy reduction maintenance setting, or ERMS mode.

In accordance with various embodiments, a system is provided for providing protection on an electrical system. The system can include memory and one or more processors, in communication with the memory, which is configured to control or implement the various operations of the method as described above (including any combination of the embodiments as described herein).

In accordance with various embodiments, a non-transitory memory medium stores computer-executable code which when executed by one or more processors implements the method as described above (including any combination of the embodiments as described herein).

### BRIEF DESCRIPTION OF THE DRAWINGS

FIG. 1 shows a diagram of an example electrical system with a dynamic circuit protection system, which can operate in various protection modes to selectively operate circuit protective device(s) at different trip settings and control access to equipment on the protected circuit, according to embodiments of the present disclosure.

FIG. 2 shows an example process of performing circuit protection in a selective manner in various protection modes and trip current threshold settings for circuit protective device(s) on the protected circuit of the electrical system, according to embodiments of the present disclosure.

FIG. 3 shows an example process of evaluating current demand that is anticipated on the protected circuit or electrical equipment thereon of the electrical system, according to embodiments of the present disclosure.

FIG. 4 shows an example process of performing circuit protection on the protected circuit using different protection modes, according to embodiments of the present disclosure.

FIG. 5 shows an example process of providing fault and other circuit protection for the protected circuit on the electrical system through circuit protective device(s), according to embodiments of the present disclosure.

FIG. 6 illustrates graphs showing example trip current threshold settings for an energy reduction maintenance setting (ERMS) mode and a non-ERMS mode, according to embodiments of the present disclosure.

FIG. 7 illustrates graphs showing example time versus current curves related to a low energy protection mode, arc flash energy boundary of incident energy, and energy demand for operation of electrical equipment, according to embodiments of the present disclosure.

### DETAILED DESCRIPTION OF EXAMPLE EMBODIMENTS

This description and the accompanying drawings illustrate example embodiments of the present disclosure and should not be taken as limiting, with the claims defining the scope of the present disclosure, including equivalents. Various mechanical, compositional, structural, electrical, and operational changes may be made without departing from the scope of this description and the claims, including equivalents. In some instances, well-known structures and techniques have not been shown or described in detail so as not to obscure the disclosure. Further, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment.

In accordance with embodiments of the present disclosure, a system and method are provided for arc fault (or arc flash fault) protection on an electrical system. The system and method can employ circuit protective device(s), such as for example circuit breaker(s), for protecting downstream circuit(s), also referred to generally as a “protected circuit”, against abnormal or hazardous electrical activity, including arc fault and resulting arc flash, as well as other fault/overload conditions, on an electrical system. The circuit protective device(s) can dynamically operate at different protection mode settings according to different trip current threshold settings for use in defining the fault and other parameters under which to trip the circuit protective device(s). The trip current threshold setting(s) can, for example, take the form of trip curve(s) or other threshold(s)/level(s) which can be predefined in advance. In operation, in response to a fault condition such as a detected arc fault or other condition in light of the trip current threshold setting(s), the circuit protective device(s) is tripped to interrupt power to the protected circuit on the electrical system.

When maintenance is to be performed by a user(s), e.g., qualified electrical personnel, on or in proximity (or near) to energized electrical equipment (or electrical component(s) thereof) on the protected circuit of the electrical system, the system and method can provide a low (or lower) energy protection mode (e.g., a maintenance protection mode), which can reduce or lower the maximum electrical energy allowed through the protected circuit of the electrical system. For example, the low energy protection mode can be used to increase protection settings for the circuit protective device(s) to a low or lower trip current threshold setting(s) so that, in the event of an arc fault, the circuit protective device(s) can trip faster, and thus, further limit the amount of allowable incident energy downstream of the circuit protective device(s) on the protected circuit of the electrical system in comparison to the trip current threshold setting(s) of the circuit protective device(s), for example, in non-maintenance protection mode. In this way, the time between fault and trip is minimized to reduce the risk of injury, such as from arc flash, when a user is performing maintenance on or in proximity to energized equipment on the protected circuit of the electrical system, thereby allowing for user maintenance on or in proximity to energized equipment on the protected circuit with minimal or no Personal Protection Equipment (PPE). For example, the term “proximity” can refer to a distance or range from energized electrical equipment, such as near, adjacent to, or at or within a distance or range which can be considered hazardous to a user. As will be described herein, in various embodiments, the low energy protection mode (e.g., maintenance protection mode) can be the default or normal protection mode of the circuit protective device(s) on the electrical system.

In the low energy protection mode, the trip current threshold setting(s) can be configured (or set) to comply with various industry or other safety standards (or requirements), including maintenance safety standards. In various embodiments, such maintenance safety standards may, for example, require operating thresholds, when performing maintenance on or in proximity to energized equipment, to be set below the arc flash boundary of incident energy, e.g., 1.2 cal/cm², which is the distance where a worker without appropriate PPE would receive second-degree burns. In other embodiments, the operating thresholds may be set in relation to other incident energy levels where minimal or reduced PPE requirements also may be employed when performing maintenance.

The low energy protection mode can be implemented under control of a computerized system, with one or more processors (or controllers), memory and input/output (I/O) interface, which may be integrated into or part of the circuit protective device(s) or may be configured to interact with the circuit protective device(s) or control system(s) thereof to control the protection modes and associated trip current threshold settings of the circuit protective device(s).

In various industries and applications, the protected circuit and equipment thereon may draw current, at various stages of operation or other normal activity, which may exceed the trip current threshold setting set to comply with maintenance protection standards. As such, when operating in the low energy protection mode, the circuit protective device(s) would trip and interrupt power to the equipment, and thus, interfere with normal operations of the equipment on the electrical system (e.g., operation of the equipment for the purpose intended as manufactured or configured or without significant changes that would impair its ability to meet its objectives).

Accordingly, in the low energy protection mode, when the current demand of the protected circuit or equipment thereon is anticipated to exceed a first trip current threshold setting (e.g., normal or default trip setting), the system and method can further temporarily (1) change (or replace) the first trip current threshold setting to (or with) a second trip current threshold setting at a high (or higher) energy protection mode, and (2) restrict (e.g., prevent, etc.) access to the equipment on the protected circuit during operation in the second trip current threshold setting. The second trip current threshold setting has a higher current mode than the first trip current threshold setting. In this way, the supply of power to equipment on the protected circuit on the electrical system does not need to be disconnected under normal operation (or operating conditions) when the current demand temporarily exceeds a trip threshold setting for user maintenance, while still allowing for user protection and for continued maintenance when current demand is or returns below the first trip current threshold setting.

By coordinating trip current threshold settings with equipment operations, the system and method can allow a user to perform maintenance operations on or in proximity to electrical equipment on the electrical system at arc energy levels meeting minimal PPE requirements, and can dynamically or automatically disallow or restrict maintenance operations when arc energy potential is temporarily increased to allow and accommodate equipment operations under normal operating conditions.

In various embodiments, the maintenance activity by a user(s) can include but is not limited to the performance of work or other activity on or in proximity to energized equipment on the protected circuit of the electrical system. Such work or other activity can include, for example, accessing, servicing, inspecting, replacing, changing, updating, removing, or adding equipment (or one or more components thereof) on the protected circuit of the electrical system or in proximity to energized equipment on the protected circuit of the electrical system, or other maintenance operations on or in proximity to energized equipment on the protected circuit of the electrical system.

In various embodiments, the protection modes of the circuit protective device(s) can include at least a first trip current threshold setting(s) and second trip current threshold setting(s). The first trip current threshold setting(s) can be a normal or default trip threshold setting(s) for the circuit protective device(s), and the second trip current threshold setting(s) can be a trip threshold setting(s), with a higher allowable current (or energy) mode than the first trip current threshold setting. In various embodiments, the first trip current threshold setting can be a current threshold which restricts an amount of incident energy on the electrical system, via the circuit protective device(s), below the arc flash boundary (e.g., below 1.2 cal/cm²), and the second trip current threshold permits incident energy above the arc flash boundary on the electrical system. In various embodiments, the first trip current threshold setting can be a setting selected from a plurality of first trip current threshold settings for a low energy protection mode, and the second trip current threshold setting can be a setting selected from a plurality of second current threshold settings for a high energy protection mode.

In various embodiments, the settings of the various protection modes and associated trip current threshold settings can be implemented using the same or different trip unit(s) on the same or different circuit protective device(s). For example, in an embodiment, the method and system may employ trip unit(s), with a faster tripping system (e.g., solenoid-based trip unit, etc.) with predefined trip curves in the low energy protection mode, and may employ conventional trip unit(s) with predefined trip curves in the high energy protection mode.

In various embodiments, the protection modes and operations associated therewith can be automated or performed under control of one or more processor(s), or computerized systems having one or more processor(s).

In various embodiments, the protection modes as described herein may be employed in an electrical system for various applications, including industrial processes or systems. Such an electrical system can include motor control center(s) or MCC(s), which may have cabinet(s)/enclosure(s) with movable and lockable drawer(s), which can house various electrical equipment including motor starter(s) for motor(s), transformers(s), circuit protective device(s), power converter(s), bus bar(s), control system(s) and other equipment which can be employed to control, power and protect the operation of motor(s) and associated equipment for an industrial process or system. The circuit protective device(s) can be provided to protect the protected circuit and electrical equipment thereon, including equipment in one or more drawers of the MCC or in proximity thereof, as well as personnel around or near such equipment.

In various embodiments, when the current demand on the protected circuit (and equipment thereon) is anticipated to exceed the first trip current threshold setting for the low energy protection mode, the drawer(s) of the MCC can be locked to restrict (e.g., prevent) movement or replacement thereof, and the trip setting can be changed from a first trip current threshold setting for the circuit protective device(s) to a second trip current threshold setting for a high energy protection mode. The second trip current threshold can be a higher allowable current mode, also sometimes referred to as higher current mode, for accommodating a higher current (or energy) demand on the protected circuit. In this way, a user is restricted from performing work or other activity on or in proximity to energized equipment on the protected circuit of the electrical system. For example, the electrical equipment on the protected circuit can be MCC drawer(s). The user can be restricted from removing or replacing drawer(s), which are locked, in the MCC or from performing any other maintenance operation on or in proximity to the electrical equipment in the locked drawer(s) or in proximity thereto in the MCC, during operation in the second trip current threshold setting.

In various embodiments, the electrical system can relate to an electrical architecture for an MCC, which can provide for group protection of multiple drawers/buckets, via the circuit protective device(s). In the low energy protection mode, the circuit protective device(s) can coordinate with motor starters, which can normally operate with protections sufficient to not require PPE for live electrical work (e.g., <1.2 cal/cm²). In the high energy protection mode, the operation of the motor starters also can be coordinated with those of the circuit protective device(s) to allow temporarily equipment operation which can exceed safety limitations (e.g., >1.2 cal/cm²), by coordinating trip current threshold settings with equipment operations (e.g., motor starting, power output increases on a variable speed drive, etc.) and by disallowing or restricting user maintenance operations which can expose users to arc flash hazard during motor starting when the trip current threshold setting is increased for operation needs.

In various embodiments, the protection modes, as described herein, also can define a separate set of parameters for other protection functions including, for example, long-time overcurrent protection, short-time overcurrent protection, instantaneous overcurrent protection, ground-fault protection, and other protection.

These and other example systems and methods or other features and benefits of the present disclosure are shown and/or described below and in the attached figures.

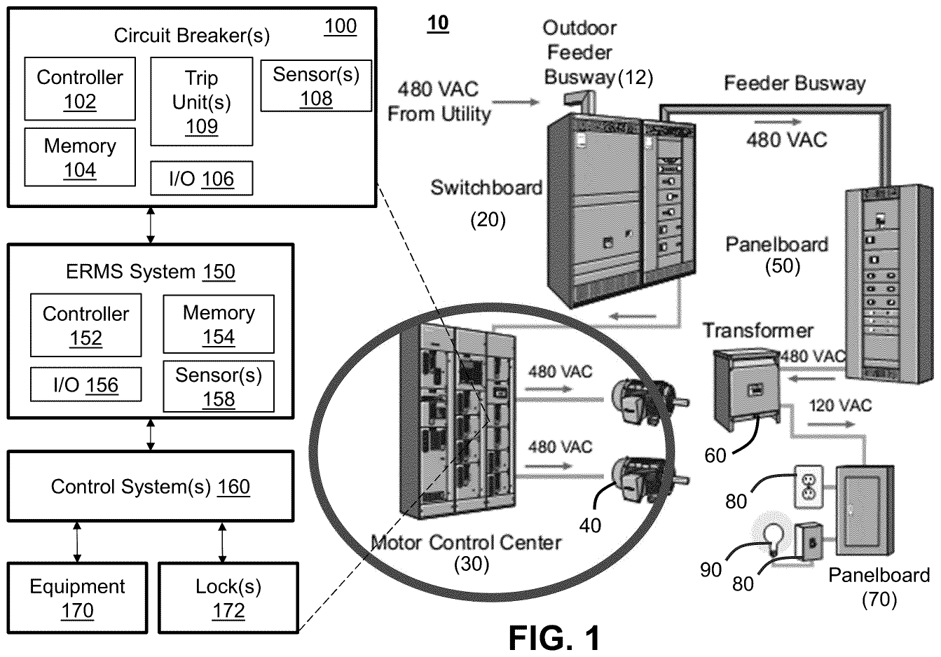

FIG. 1 shows a diagram illustrating an example electrical system 10 with circuit protective device(s), such as for example circuit breaker(s), to provide arc fault and other circuit protection on circuit(s) of the electrical system 10, according to embodiments of the present disclosure. Such circuit(s), which are protected by circuit protective device(s), are generally referred herein as protected circuit. The electrical system 10 can be designed for various applications, including industrial processes, systems, and/or facilities. The circuit protective device(s) can operate (or be controlled to operate) in or according to different protection modes at different trip current threshold settings to control the trip speed of the circuit protective device(s), and the allowable incident energy on the protected circuit on the electrical system 10, according to desired protection level(s).

As will be described herein, the protection modes can include at least a low energy protection mode, and a high energy protection mode. The low energy protection mode can be a maintenance protection mode such as an ERMS mode or function, or other maintenance-type protection mode for protected circuit of the electrical system. In various embodiments, the low energy protection mode is the normal or default protection mode implemented by the circuit protective device(s) on the electrical system, such as for example during normal operation of the electrical equipment on the electrical system.

The low energy protection mode can include a plurality of trip current threshold settings for the circuit protective device(s) which can allow for maintenance, if desired, on or in proximity to electrical equipment on the protected circuit of the electrical system, according to embodiments of the present disclosure. In the low energy protection mode, the trip setting for the circuit protective device(s) can be a first trip current threshold setting(s), which can limit the allowable incident energy on the electrical system 10 (or to electrical component(s) thereof) to current level(s) that are suitable to enable maintenance by a user on electrical equipment or in proximity thereof on the electrical system 10 with minimal, limited, reduced or no PPE. In various embodiments, the first trip current threshold setting(s) can be configured to restrict the maximum allowable energy on the electrical system 10 (or component(s) thereof) below the arc flash boundary of incident energy of 1.2 cal/cm², or other incident energy level(s) at which user maintenance at or around energized equipment with minimal or no PPE is acceptable.

Furthermore, in the high energy protection mode, the trip setting(s) for the circuit protective device(s) can be a second trip current threshold setting(s), which can be used to change (or replace) temporarily the first trip current threshold setting(s), when current demand by the electrical system 10 (or component(s) thereof) is anticipated to exceed temporarily the restriction or limitation of the first trip current threshold setting(s) during normal operation of equipment on the electrical system 10. The second trip current threshold setting(s) is a high or higher current mode for slower tripping of the circuit protective device(s), than the first trip current threshold setting(s), which is a low or lower current mode for the protected circuit. When operating in the second trip current threshold setting(s), the user is restricted from performing maintenance on or in proximity to energized equipment on the electrical system. For example, the energized equipment can be moved and/or locked to restrict access at or around energized equipment or other equipment in proximity to the energized equipment on the electrical system 10. Accordingly, in the high energy protection mode, the electrical system 10 can be protected at a higher or high current (or energy) mode, to accommodate additional current demands when needed, while still providing for protection against electrical hazards on the electrical system 10.

In this example, the electrical system 10 can include an electrical bus system, which can supply power from a power source (e.g., Utility, etc.) to one or more loads, across various electrical distribution equipment. As shown, the electrical distribution equipment can include an outdoor feeder busway 12, which can supply power to one or more loads, such as motors 40 or other load(s), across a switchboard 20 and a motor control center (MCC) 30. The MCC 30 can include one or more electrical cabinet(s)/enclosure(s) having a plurality of drawers (also referred to as “buckets”) for housing electrical equipment, which is configured to be connected to or disconnected from the electrical system 10. The drawers can include electrical equipment, which can be energized, during normal operation. In this example, the electrical equipment in the drawers and/or cabinet(s)/enclosure(s) of the MCC can include motor starter(s) and other electrical equipment for controlling the operations of one or more motors 40. In the electrical system 10, circuit protective device(s) can be configured to provide protection for downstream electrical equipment in one or more drawers on the protected circuit. In this example, the circuit protective device(s) can be a circuit breaker(s) 100.

The drawers of the MCC 30 can be configured to be moveable or slidable between various positions, to be removable and replaceable, and to be lockable between a locked state in which the drawers are locked in position and cannot be removed or replaced and a locked state in which the drawers are movable or slidable and can be removed or replaced from the MCC cabinet/enclosure. In various embodiments, the drawers can be racked-in to or racked-out from the MCC cabinet/enclosure, when adding or removing the drawers and their equipment from the MCC 30 of the electrical system 10. For example, a drawer can be racked-in to establish electrical connections between equipment in the drawer and bus bars of the electrical distribution equipment, and to establish other connections, including communication connections, with other devices and systems in the MCC 30 or on the electrical system 10.

The electrical distribution equipment also can include a panelboard 50, transformer 60, panelboard 70, and outlet(s)/switch(es) 80, across which power is supplied from the power source (e.g., Utility, etc.) to one or more load(s) 90, such as light bulb(s) or fixtures, etc.

As further shown in FIG. 1, in this example, the maintenance protection mode can be implemented under control of an ERMS system 150 (or other maintenance protection system), the circuit protective device(s) can be circuit breaker(s) 100, and a control system(s) 160 can be configured to control the operations of equipment 170 on the electrical system 10, operations of enclosure of the MCC 30 and other equipment (e.g., enclosure/cabinet/drawer(s) of the MCC, etc.), the ERMS system 150, and/or the circuit breaker(s) 100. In this example, the equipment 170 can be located in the MCC 30, such as in movable and lockable drawer(s) or in proximity to the equipment in the drawer(s) in the cabinet/enclosure of the MCC 30. Lock(s) 172 of the drawer(s) can be an electronic or mechanical lock(s), which can be controlled to unlock the drawer(s) to enable access to the equipment therein or in the enclosure/cabinet of the MCC 30, including removal or replacement of the drawer(s) or to lock the drawer(s) to prevent access to the equipment in the drawer(s) or other equipment in proximity thereto in the enclosure/cabinet of the MCC 30.

The circuit breaker(s) 100 can include a controller 102, a memory 104, input/output (I/O) 106 for communicating data with other devices or systems, sensor(s) 108 and trip unit(s) 109. The controller 102 can be configured to control or implement the various operations of the circuit breaker(s) 100, including control of the tripping operations according to the selected protection modes (e.g., a low-energy protection mode, high energy protection mode or other protection modes) and their associated trip current threshold settings, including those as described herein. The memory 104 can store various data, including mode/trip parameters and settings, for implementing the various operations described herein.

In operation, the controller 102 is configured to select the trip current threshold setting according to the protection mode, and implement trip operations according to a trip current threshold setting based on the selected protection mode, e.g., a low-energy protection mode, high energy protection mode, or other protection modes. The trip current settings for the different protection modes can be associated with defined trip curves, for which data can be stored in the memory 104. The circuit breaker(s) 100 can be configured to provide downstream circuit protection, including protection for a single drawer and its equipment or for multiple drawers and their equipment (e.g., group protection) on the MCC 30.

The ERMS system 150 can be configured to control dynamically or selectively the operation of the protection modes through the circuit breaker(s) 100. The ERMS system 150 can include a controller 152, memory 154, and input/output 156 for communicating data with other devices or systems, including for example the circuit breaker(s) 100, control system(s) 160 or other devices or systems. The ERMS system 150 also can include sensor(s) 158 for monitoring electrical energy on the electrical system, and outputting information concerning the monitored electrical energy. The sensor(s) 158 can include current, voltage and/or other sensor(s) for sensing, monitoring, determining and/or deriving characteristics of the electrical energy on the electrical system 10 and protected circuit thereon. The controller 152 can control the components and operations of the ERMS system 150, including those described herein. The memory 154 can store various data, including mode/trip parameters and settings, for implementing the various operations described herein.

In various embodiments, the low-energy protection mode can be the normal/default protection mode on the electrical system 10. For example, when the electrical system 10 is powered ON for operation, the circuit breaker(s) 100 can be configured to operate in the low energy protection mode (e.g., at a trip current threshold setting(s) which can provide for arc flash protection and allow for user maintenance on or in proximity to electrical equipment on the protected circuit of the electrical system).

In various embodiments, in the low energy protection mode, the controller 152 is configured to control the operations of the circuit breaker(s) 100 to restrict allowable incident energy downstream of the breaker 100 on the electrical system 10, according to a first current threshold setting, which can allow for maintenance to be performed by a user with minimal or no PPE on or in proximity to downstream energized equipment on a branch circuit of the electrical system 10. For example, in the low energy protection mode, under control of the ERMS system 150, the circuit breaker(s) 100 can operate at the first current threshold setting, which when exceeded, causes the circuit breaker(s) 100 to trip, via the trip unit(s) 109, and interrupt power to the protected circuit on the electrical system 10.

Furthermore, the controller 152 is further configured to determine the current demand anticipated on the branch circuit or equipment thereon of the electrical system 10. The anticipated current demand can be determined based on an anticipated operation of equipment (or component(s) thereof) or combination of equipment on the branch circuit of the electrical system 10. The anticipated operation can be determined from information provided by the control system(s) 160. For example, the control system(s) 160, which can control the equipment in the drawer(s), can inform the ERMS system 150 of the anticipated equipment operation from which the anticipated current demand can be ascertained, can provide information regarding the anticipated current demand or the anticipated need for additional current demand or high current mode in relation to the maintenance mode. In some embodiments, the control system(s) 160 can transmit a request, such as a request for a high current mode or low current mode, to the ERMS system 150 which can be associated with operational stages of equipment in an industrial or other process. Furthermore, alternatively or in addition, the anticipated operation can be determined based on sensed or monitored energy measurements (e.g., voltage, current, power, etc.) from sensor(s) 108 or other sensor(s) (e.g., sensor(s) 158, etc.) or derived therefrom. The sensed or monitored energy measurements can be compared to anticipated operation or operating profile(s) of the equipment or combination of equipment to ascertain the anticipated operating state of the equipment or combination of equipment and the associated anticipated current demand.

When the anticipated current demand exceeds the first trip current threshold setting, the controller 152 is further configured to change (or replace) temporarily the trip setting of the circuit breaker(s) 100 from the first trip current threshold setting for a low energy protection mode to a second trip current threshold setting for a high energy protection mode. The second current threshold setting is a higher current mode than the first trip current threshold setting, to accommodate the additional anticipated current demand of the equipment (or combination of different equipment) on the protected circuit under normal operations thereof. During operation at the second trip current threshold setting, the controller 152 is also configured to restrict (e.g., prevent, etc.) user access to energized equipment (e.g., in the MCC 30) on the branch circuit on the electrical system 10. For example, the controller 152 of the ERMS system 150 can, directly or indirectly through the control system(s) 160, move a position of the energized equipment (or enclosure/housing thereof) and/or lock via the lock(s) 172 the energized equipment in an enclosure/housing, thereby restricting (e.g., preventing, etc.) user maintenance on or in proximity to energized equipment on the electrical system 10. For example, the drawer(s)/bucket(s) in the electrical cabinet/enclosure of the MCC 30 can be moved and/or locked in place to prevent user access to energized equipment in the drawer(s)/bucket(s), or in the electrical cabinet/enclosure of the MCC 30.

When the current demand no longer exceeds (or is below) the first trip current threshold setting, the controller 152 is further configured to change or return the trip setting of the circuit breaker(s) 100 from the second trip current threshold setting for the high energy protection mode to the first second trip current threshold setting for the low energy protection mode, and to move and/or unlock equipment to allow user maintenance on or in proximity to the equipment on the protected circuit. For example, the drawer(s)/bucket(s) in the electrical cabinet/enclosure of the MCC 30 can be moved and/or unlocked to allow user access to equipment in the drawer(s)/bucket(s), or in the electrical cabinet/enclosure of the MCC 30. When unlocked, the drawer(s) can be removed and replaced, or equipment therein or in proximity thereto in the MCC 30 can be accessed.

Although the ERMS system 150 is shown as a separate system or device, it should be understood that, in various embodiments, the functions of the ERMS system 150, including the low and/or high energy maintenance protection mode(s) and other protection modes (as described herein) can be integrated into and implemented through the circuit breaker(s) 100 or the control system 160.

The control system(s) 160 can be configured to control equipment 170, such as equipment on the circuit protected and associated therewith (e.g., enclosure(s)/cabinet(s)/drawer(s), lock(s) 172, etc.). The control system(s) 160 can be a computerized system, which can include processor(s), memory, Input/Output (I/O) for communicating with remote devices or systems, and other components for facilitating control and operations, including for various protection modes, as described herein. In various embodiments, the control system(s) 160 can control the operations of the equipment 170 in coordination with the various protection modes and associated trip current threshold settings under control or implemented through the ERMS system 150 and circuit breaker(s) 100, including the example coordinated operations as described herein. The control system(s) 160 can be a local control system, central control system or part of a distributed control system of an industrial process or sub-process thereof.

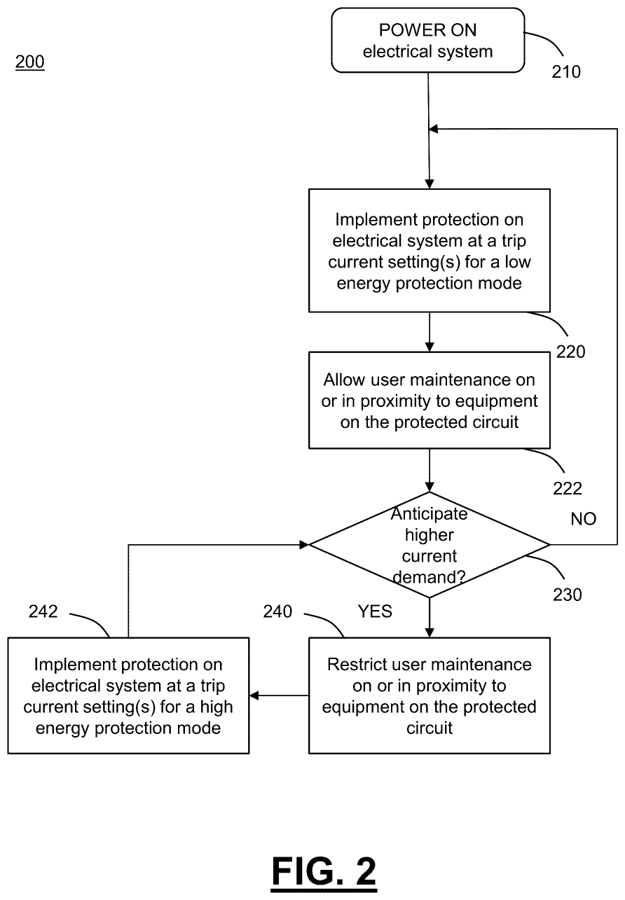

FIG. 2 shows an example process 200 of selectively performing circuit protection in various protection modes and trip current settings for circuit protective device(s) on an electrical system, according to embodiments of the present disclosure. The process 200 can be implemented by or under control of one or more processors of one or more devices or systems, which may coordinate with one another. The device(s) or system(s) can include the circuit protective device(s), ERMS system, control system for equipment on the electrical system, or other computer-implemented device(s) or system(s).

At block 210, the power on the electrical system is turned ON to supply electrical power to circuit(s) with electrical equipment (or electrical component(s) thereof) on the electrical system. The circuit(s) are protected by circuit protective device(s), and are generally referred herein as protected circuit.

At block 220, circuit protection is implemented on the protected circuit through the circuit protective device(s) at a trip current setting for a low energy protection mode. The trip current setting can be a first trip current threshold setting, which restricts the maximum allowable incident energy on the protected circuit to acceptable energy levels for user maintenance at or around energized equipment on the protected circuit of the electrical system. For example, the first trip current threshold setting for the circuit protective device(s) can be configured to restrict the maximum allowable incident energy on the protected circuit below the arc flash boundary (e.g., 1.2 cal/cm², etc.) or other suitable incident energy level(s) for user maintenance with minimal or no PPE.

At block 222, user maintenance is allowed (or unrestricted) on or in proximity to equipment on the protected circuit of the electrical system. For example, access to the electrical equipment (or surrounding areas) on the protected circuit is allowed on the electrical system, such as for user maintenance on or in proximity to the equipment. In various embodiments, the equipment (or component(s) thereof) or associated enclosure(s) is unlocked to allow user access to the equipment or areas around the equipment.

At block 230, a determination is made on whether a higher current demand, e.g., higher than allowed by the first trip current threshold setting, is anticipated on the protected circuit of the electrical system. If a higher current demand is not anticipated on the protected circuit, the process 200 returns back to block 220. Otherwise, if a higher current demand is anticipated on the protected circuit, the process 200 proceeds to block 240.

At block 240, user maintenance is restricted (e.g., prevented, etc.) on or in proximity to equipment on the protected circuit. For example, user access to the equipment on the protected circuit is restricted. In various embodiments, the equipment may be locked in an enclosure to restrict access thereto, including areas/regions within a distance around the equipment which are considered hazardous when the equipment is energized.

At block 242, circuit protection is implemented, for example, temporarily, on the protected circuit of the electrical system through the circuit protective device(s) at a second trip current threshold setting for accommodating the anticipated current demand on the protected circuit under normal operating conditions. The second current threshold setting is for a high energy protection mode. The second current threshold setting also can be selected from a plurality of second trip current threshold settings, based on various factors including but not limited to the anticipated amount of current demand for the protected circuit, the anticipated period for the higher current demand, the operational stage of the application process which is anticipated to be implemented (e.g., motor starting, or other operation stage(s)), and/or other operating factors on the protected circuit on the electrical system, on other circuit(s) on the electrical system, or on the process application.

In various embodiments, the circuit protective device(s) can operate at the second trip current threshold setting for a predefined period for the anticipated higher current demand, or until the higher current demand is no longer needed. The trip setting for the circuit protective device(s) is thereafter returned to the first trip current setting afterwards or to a trip setting suitable for user maintenance.

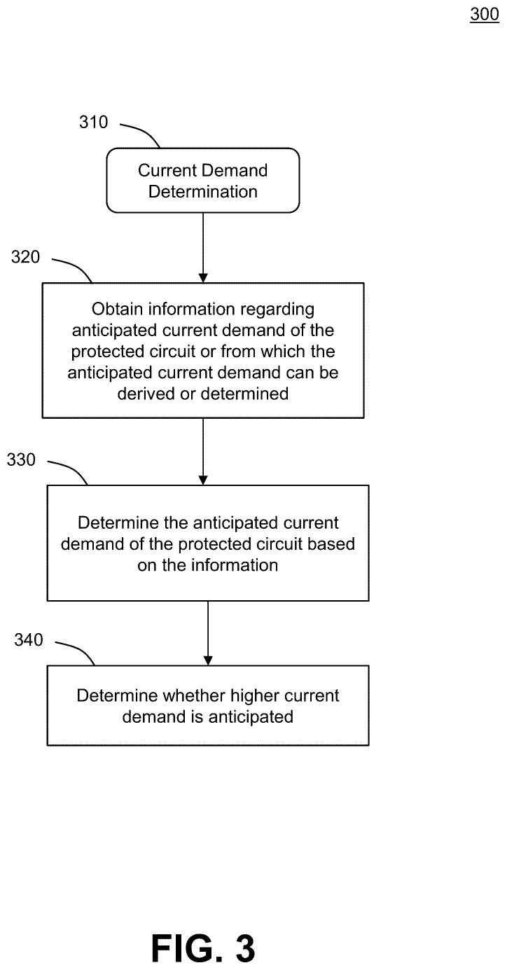

FIG. 3 shows an example process 300 of evaluating current demand on protected circuit of the electrical system, according to embodiments of the present disclosure. The process 300 can be implemented by or under control of one or more processors of one or more devices or systems, which may coordinate with one another. The device(s) or system(s) can include the circuit protective device(s), ERMS system, control system for equipment on the electrical system, or other computer-implemented device(s) or system(s).

At block 310, the process 300 initiates current demand determination for a protected circuit.

At block 320, information is obtained regarding anticipated current demand of the circuit (including equipment thereon) protected by the circuit protective device(s) or from which the anticipated current demand of the protected circuit can be derived or determined. As previously discussed, such information can, for example, be obtained from the control system for the equipment on the electrical system (e.g., a request for high/low current demand, operating stage information, etc.), from sensor(s) for monitoring electrical energy on the protected circuit, or from other device(s) or system(s) for controlling the operations of the device(s) or system(s) on the electrical system.

At block 330, the anticipated current demand of the protected circuit is determined based on the obtained information.

At block 340, a determination is made on whether higher current demand, e.g., higher than allowed by the first trip current threshold setting, is anticipated on the protected circuit of the electrical system.

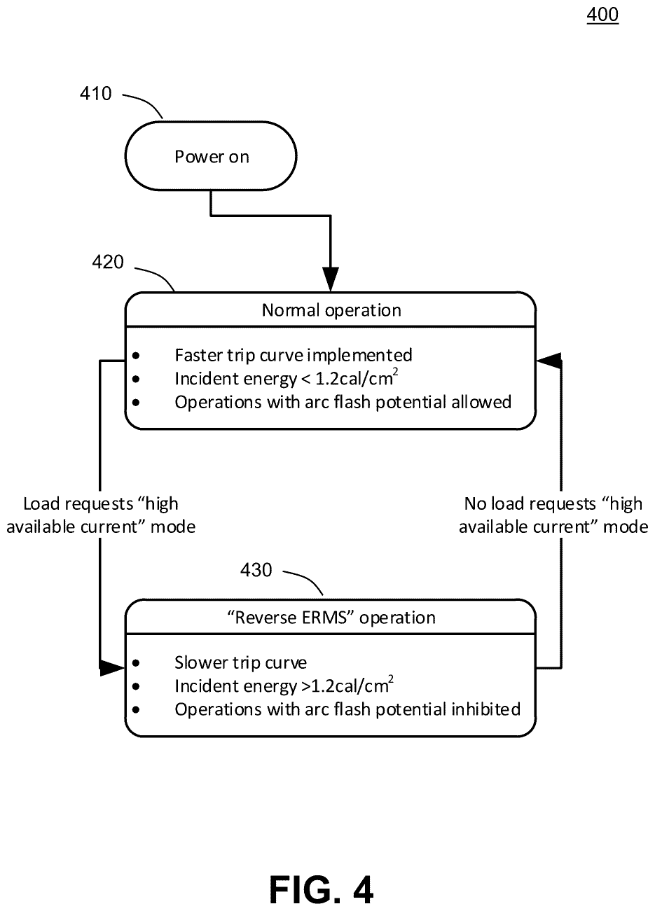

FIG. 4 shows an example process 400 of dynamically performing circuit protection in a low energy protection mode or a high energy protection mode for circuit protective device(s), according to embodiments of the present disclosure. The process 400 can be implemented by or under control of one or more processors of one or more devices or systems, which may coordinate with one another. The device(s) or system(s) can include the circuit protective device(s), ERMS system, control system for equipment on the electrical system, or other computer-implemented device(s) or system(s).

The process 400 begins at block 410 in which the protected circuit is energized on the electrical system.

At block 420, the circuit protective device(s) is set to operate at a first trip current threshold setting, in the low energy protection mode (e.g., maintenance protection mode). The first trip current threshold setting allows for user maintenance, e.g., operations with arc flash potential allowed. For example, the first trip current threshold setting can be configured to restrict the maximum allowable incident energy on the protected circuit below the arc flash boundary, e.g., <1.2 cal/cm², and provide a faster trip curve. The first trip current threshold setting can be implemented on the circuit protective device(s) when (or so long as) there are no load requests for a “high available current” mode. In various embodiments, the low energy protection mode and its associated first trip current threshold setting(s) can be the default or normal mode of operation for the circuit protective device(s) on the electrical system.

At block 430, if a load request for “high available current” mode is requested, the circuit protective device(s) is set to operate at a second trip current threshold setting for a high energy protection mode, to accommodate a higher current demand which is anticipated on the protected circuit of the electrical system. For example, the second trip current threshold setting can be configured to allow the maximum allowable incident energy on the protected circuit to exceed the arc flash boundary, e.g., >1.2 cal/cm², and can have a slower trip curve than the first trip current threshold setting. At the second trip current threshold setting, which is a higher current mode, user maintenance is not allowed at or in proximity to energized equipment on the protected circuit, e.g., operations with arc flash potential are inhibited.

When the higher current demand is no longer needed, the trip setting of the circuit protective device(s) can be returned or changed from the second trip current threshold setting for the high energy protection mode to the first trip current threshold setting for the low energy protection mode.

In various embodiments, the need for a lower or higher current demand, and thus, for the first or second trip current threshold setting on the protected circuit, can be determined according to a request (e.g., a load request for high available current or a load request for low available current) or other information obtained, such as described herein.

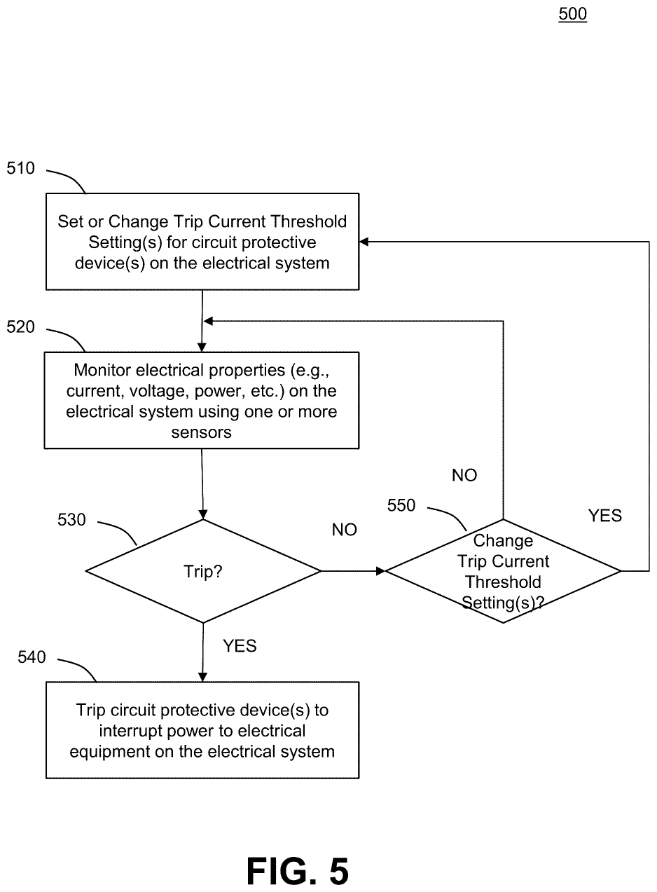

FIG. 5 shows an example process 500 of protecting a circuit(s) on an electrical system from an arc fault condition through circuit protective device(s), according to embodiments of the present disclosure. By way of example, the various operations of the process 500 can be controlled or performed by one or more processors of the circuit protective device(s), or by one or more processors of the circuit protective device(s) in combination with the ERMS system and/or the control system for controlling the equipment on or associated therewith on the electrical system.

At block 510, the circuit protective device(s) is set or changed to operate at a desired trip current threshold setting from a plurality of trip current threshold settings, according to at least the protection mode, e.g., low energy protection mode (e.g., maintenance protection mode), high energy protection mode, etc. In various embodiments, the normal or default protection mode for the circuit protective device(s) can be the low energy protection mode and its associated trip current threshold setting(s).

At block 520, electrical properties (e.g., current, voltage, power, etc.) are monitored on the protected circuit of the electrical system. The monitored electrical properties can be current, voltage, power or other electrical property, which can be sensed from a sensor(s) or derived from sensed data from the sensor(s).

At block 530, a determination is made whether to perform a tripping operation, via the circuit device(s) based on the monitored electrical properties on the protected circuit. For example, if the monitored current exceeds the trip current threshold setting, the circuit protective device(s) performs a tripping operation to interrupt power on the protected circuit, at block 540. Otherwise, if the monitored current does not exceed the trip current threshold setting, the process 500 proceeds to block 550.

At block 550, a determination is made whether to change the trip current threshold setting for the circuit protective device(s). For example, the trip current threshold setting for the circuit protective device(s) can be changed when the type of protection mode is changed (e.g., a change from a low energy protection mode to a high energy protection mode, or vice-a-versa), according to an anticipated current demand on the protected circuit according to the type of protection mode, according to an anticipated operation or operational stage of equipment or combination of equipment on the protected circuit, according to user input or command, or according to other factors associated with user safety.

If the trip current threshold setting for the circuit protective device(s) is to be changed, the process 500 proceeds to block 510. Otherwise, if the trip current threshold setting for the circuit protective device(s) is retained or not changed, the process 500 proceeds to block 520.

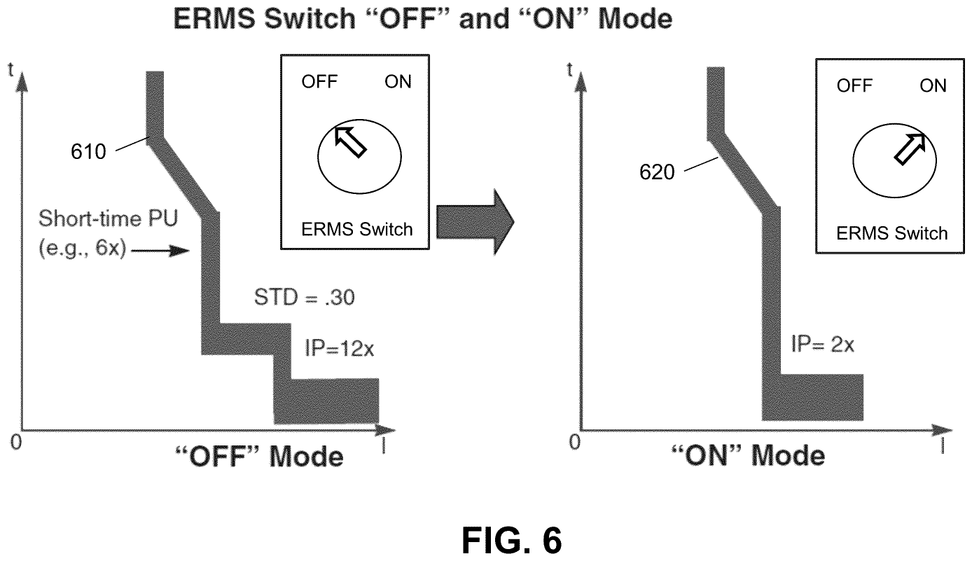

FIG. 6 illustrates graphs showing example trip current threshold settings, e.g., trip curves, for a normal or non-ERMS protection mode and a ERMS protection mode, according to embodiments of the present disclosure. As shown, the trip curve 610 is an example of a trip current threshold setting for the circuit protective device(s) when the ERMS mode is disengaged or OFF. The trip curve 620 is an example of a normal or default trip current threshold setting for the circuit protective device(s) when the ERMS mode is engaged or ON. In this example, the trip curve 620 of trip current setting for the ERMS mode is faster, with a lower allowable incident energy on the protected circuit, than the trip curve 610 of the trip current setting for the normal protection mode.

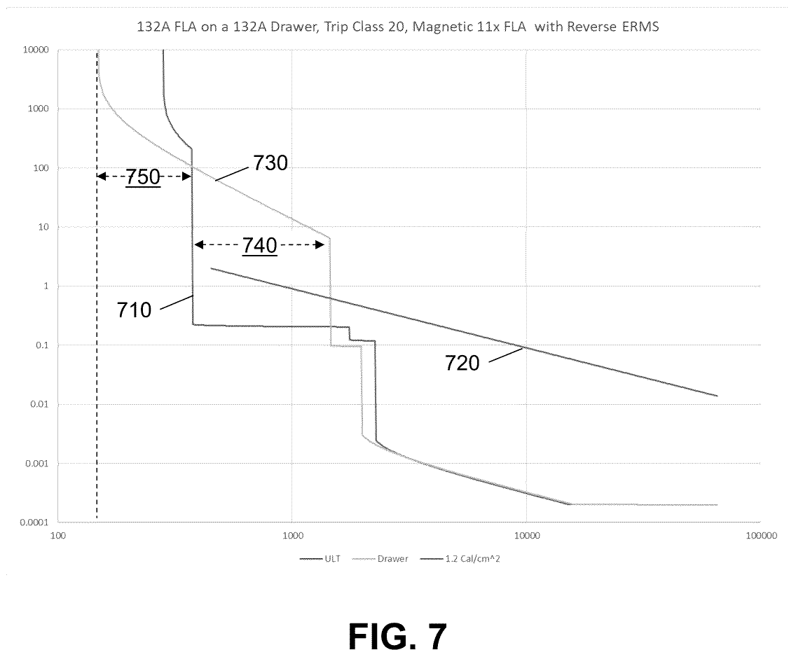

FIG. 7 illustrates graphs showing example time (t) versus current (I) curves related to low energy protection mode, arc flash energy boundary of incident energy, and energy demand for operation of electrical equipment, according to embodiments of the present disclosure. Example curves of time (t) versus current (I) are shown of a trip curve 710 of the trip current threshold setting for a circuit protective device(s) in the low energy protection mode, of an energy curve 720 of the arc flash boundary (e.g., 1.2 Cal/cm²), and an energy curve 730 of a MCC drawer(s). The region, generally denoted by the reference 740, shows an operating region of the equipment, such as for example equipment in an MCC drawer(s) during an operating stage (e.g., motor starting), where the current demand of the equipment would exceed the trip curve 710 of the trip current threshold setting in the low energy protection mode. Thus, when the current demand is anticipated to exceed the trip curve 710, the trip current threshold setting of the protective circuit device(s) can be changed from the trip curve 710 to a suitable trip curve for a high energy protection mode to accommodate the higher current demand of the equipment on the protected circuit of the electrical system.

By way of example, in the low energy protection mode, the circuit protective device(s) can operate according to the trip current threshold setting, e.g., the trip curve 710. An example of an operating region for the electrical equipment in the low energy protection mode is shown by the region designated by reference number 750. In this setting, the circuit protective device(s) is configured with a fast trip time (e.g., ˜200 ms) for currents 375 A-2.2 kA, unless the MCC drawer (or equipment therein) asks or requests for more. When the MCC drawer sees more than 2.5× its FLAmax (e.g., during motor starting or stall conditions), a signal can be sent to the circuit protective device(s) requesting “high current mode”, which in turn changes the trip setting for the circuit protective device(s) from the low energy protection mode to the high energy protection mode to accommodate the additional energy demands of the electrical system (e.g., in the region 740). In the high energy protection mode, the drawer can also be locked to prevent user maintenance on or in proximity to equipment in the drawer.

It is understood that embodiments of the disclosure herein may be configured as a system, method, or combination thereof. Accordingly, embodiments of the present disclosure may be comprised of various means including hardware, software, firmware or any combination thereof.

It should also be understood that the example embodiments disclosed and taught herein are susceptible to numerous and various modifications and alternative forms. Thus, the use of a singular term, such as, but not limited to, “a” and the like, is not intended as limiting of the number of items. Furthermore, the naming conventions for the various components, functions, characteristics, thresholds, and other elements used herein are provided as examples, and can be given a different name or label. The use of the term “or” is not limited to exclusive “or”, but can also mean “and/or”.

It will be appreciated that the development of an actual, real commercial application incorporating aspects of the disclosed embodiments will require many implementation specific decisions to achieve the developer's ultimate goal for the commercial embodiment. Such implementation specific decisions may include, and likely are not limited to, compliance with system related, business related, government related and other constraints, which may vary by specific implementation, location and from time to time. While a developer's efforts might be complex and time consuming in an absolute sense, such efforts would nevertheless be a routine undertaking for those of skill in this art having the benefit of this disclosure.

Using the description provided herein, the example embodiments may be implemented as a machine, process, or article of manufacture by using standard programming and/or engineering techniques to produce programming software, firmware, hardware, or any combination thereof.

Any resulting program(s), having computer-readable program code, may be embodied on one or more tangible or non-transitory computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable or storage medium or in any transmitting medium which transmits such a program.

A processor(s), controller(s) or processing unit(s) as described herein can be a processing system, which can include one or more processors, such as CPU, controllers, ASICs, or other processing units or circuitry, which controls or performs the operations of the devices or systems, described herein. Memory/storage devices can include, but are not limited to, disks, solid state drives, optical disks, removable memory devices such as smart cards, SIMs, WIMs, semiconductor memories such as RAM, ROM, PROMS, etc. Transmitting mediums or networks can include, but are not limited to, transmission via wireline communication, wireless communication (e.g., Radio Frequency (RF) communication, Bluetooth®, Wi-Fi, Li-Fi, etc.), the Internet, intranets, telephone/modem-based network communication, hard-wired/cabled communication network, satellite communication, and other stationary or mobile network systems/communication links.

The flowchart and block diagrams in the Figures illustrate the architecture, functionality and/or operation of possible implementations of various embodiments of the present disclosure. In this regard, each block in the flowchart or block diagrams may represent a module, segment or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments and applications of the present disclosure have been illustrated and described, it is to be understood that the present disclosure is not limited to the precise construction and compositions disclosed herein and that various modifications, changes, and variations can be apparent from the foregoing descriptions without departing from the invention as defined in the appended claims. It is understood that components, features and functionality in various embodiments as described herein can be incorporated into other embodiments.

While several embodiments of the present disclosure have been shown and described herein, it is to be understood that the above description is intended to be illustrative, and not restrictive. Many other implementation examples are apparent upon reading and understanding the above description. Although the disclosure describes specific examples, it is recognized that the systems and methods of the disclosure are not limited to the examples described herein, but may be practiced with modifications within the scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

I/We claim:

1. A method of providing protection on an electrical system, the method comprising:
implementing a low energy protection mode at a first trip current threshold setting for a circuit protective device(s) of the electrical system to provide arc flash protection and allow for user maintenance on or in proximity to electrical equipment on a protected circuit of the electrical system; and
if a higher current demand by the protected circuit or the electrical equipment thereon is anticipated to exceed the first trip current threshold setting, (1) temporarily changing the first trip current threshold setting to a second trip current threshold setting for the circuit protective device(s) to accommodate the higher current demand at a high energy protection mode and (2) restricting user maintenance on or in proximity to the electrical equipment during operation at the second trip current threshold setting, the second trip current threshold setting providing for higher allowable current on the protected circuit than the first trip current threshold setting.

2. The method according to claim 1, wherein the first trip current threshold setting for the circuit protective device(s) is configured to prevent arc flash greater than or equal to an incident energy of 1.2 cal/cm².

3. The method according to claim 1, wherein the first trip current threshold setting is a default or normal trip current setting, and the second trip current threshold setting comprises a trip current setting up to an overcurrent limit of the electrical equipment.

4. The method according to claim 1, further comprising:
monitoring current on the protected circuit or the electrical equipment thereon of the electrical system using one or more sensors; and
determining the anticipated higher current demand by the protected circuit or the electrical equipment thereon based on the monitored current.

5. The method according to claim 1, further comprising:
determining the anticipated higher current demand by the protected circuit or the electrical equipment thereon based on a request for a higher or lower current mode for the protected circuit or based on information reflecting a higher or lower current demand in view of an anticipated activity or operation of the electrical equipment on the protected circuit.

6. The method according to claim 5, wherein the anticipated activity or operation comprises motor starting or stall conditions associated with motor starting equipment housed in one or more drawers of one or more cabinets of a motor control center, or increasing power output on a variable speed drive.

7. The method according to claim 1, wherein the preventing user maintenance comprises:
locking or moving a position of an enclosure or component thereof for the electrical equipment on the protected circuit during operation at the second trip current threshold setting for the circuit protective device(s).

8. The method according to claim 7, wherein the electrical equipment comprises a motor starter(s), and the enclosure comprises a lockable drawer(s) of a motor control center.

9. The method according to claim 1, further comprising:
returning a trip setting from the second trip current threshold setting to the first trip current threshold setting for the circuit protective device(s) on the electrical system; and
allowing user maintenance on or in proximity to the electrical equipment on the electrical system.

10. A system for providing protection on an electrical system, the system comprising:
a memory; and
one or more processors, in communication with the memory, configured to:
implement a low energy protection mode at a first trip current threshold setting for a circuit protective device(s) of an electrical system to provide arc flash protection and allow for user maintenance on or in proximity to electrical equipment on a protected circuit of the electrical system; and
if a higher current demand by the protected circuit or the electrical equipment thereon is anticipated to exceed the first trip current threshold setting, (1) temporarily change the first trip current threshold setting to a second trip current threshold setting for the circuit protective device(s) to accommodate the higher current demand at a high energy protection mode and (2) restrict user maintenance on or in proximity to the electrical equipment during operation at the second trip current threshold setting, the second trip current threshold setting providing for higher allowable current on the protected circuit than the first trip current threshold setting.

11. The system according to claim 10, wherein the first trip current threshold setting for the circuit protective device(s) is configured to prevent arc flash greater than or equal to an incident energy of 1.2 cal/cm².

12. The system according to claim 10, wherein the first trip current threshold setting is a default or normal trip current setting, and the second trip current threshold setting comprises a trip current setting up to an overcurrent limit of the electrical equipment.

13. The system according to claim 10, wherein the one or more processors are further configured to:
monitor current on the protected circuit or the electrical equipment thereon of the electrical system using one or more sensors; and
determine the anticipated higher current demand by the protected circuit or electrical equipment thereon based on the monitored current.

14. The system according to claim 10, wherein the one or more processors are further configured to:
determine the anticipated higher current demand by the protected circuit or the electrical equipment thereon based on a request for a higher or lower current mode for the protected circuit or based on information reflecting a higher or lower current demand in view of an anticipated activity or operation of the electrical equipment on the protected circuit.

15. The system according to claim 14, wherein the anticipated activity or operation comprises motor starting or stall conditions associated with motor starting equipment housed in one or more drawers of one or more cabinets of a motor control center, or increasing power output on a variable speed drive.

16. The system according to claim 10, wherein to prevent user maintenance, the one or more processors are configured to:
cause an enclosure or component thereof for the electrical equipment on the protected circuit to be locked or moved during operation at the second trip current threshold setting for the circuit protective device(s).

17. The system according to claim 16, wherein the electrical equipment comprises a motor starter(s), and the enclosure comprises a lockable drawer(s) of a motor control center.

18. The system according to claim 10, wherein the one or more processors are further configured to:
determine whether current to the electrical equipment on the protected circuit exceeds the second trip current threshold setting; and
in response to the determination that the current exceeds the second trip current threshold setting, trip the circuit protective device(s) to interrupt current to the protected circuit of the electrical system.

19. The system according to claim 10, wherein the one or more processors are further configured to:
return a trip setting from the second trip current threshold setting to the first trip current threshold setting for the circuit protective device(s) on the electrical system; and
allow user maintenance on or in proximity to the electrical equipment on the electrical system.

20. The system according to claim 19, wherein the trip setting is returned from the second trip current threshold setting to the first trip current threshold setting, after a predefined period of time or if the anticipated current demand by the electrical equipment on the protected circuit would no longer exceed the first trip current threshold setting.

21. The system according to claim 10, wherein the circuit protective device(s) comprises a circuit breaker(s).

22. A non-transitory memory medium storing computer-executable code which when executed by one or more processors implements a method of providing protection on an electrical system, the method comprising:
implementing a low energy protection mode at a first trip current threshold setting for a circuit protective device(s) of the electrical system to provide arc flash protection and allow for user maintenance on or in proximity to electrical equipment on a protected circuit of the electrical system; and
if a higher current demand by the protected circuit or the electrical equipment thereon is anticipated to exceed the first trip current threshold setting, (1) temporarily changing the first trip current threshold setting to a second trip current threshold setting for the circuit protective device(s) to accommodate the higher current demand at a high energy protection mode and (2) restricting user maintenance on or in proximity to the electrical equipment on the electrical system during operation at the second trip current threshold setting, the second trip current threshold setting providing for higher allowable current on the protected circuit than the first trip current threshold setting.
